(19) United States
(12) Patent Application Publication
(10) Pub. No.: US 2025/0061350 A1
(43) Pub. Date: Feb. 20, 2025

(54) Attributing Loss of Engagement with an Online System Using Temporal Partitioning of Training Data for a Churn Prediction Model

(71) Applicant: Maplebear Inc., San Francisco, CA (US)

(72) Inventors: Ganesh Krishnan, San Francisco, CA (US); Sharath Rao Karikurve, Berkeley, CA (US); Angadh Singh, Dublin, CA (US); Changyao Chen, New York, NY (US); Tilman Drerup, Palo Alto, CA (US)

(21) Appl. No.: 18/233,828

(22) Filed: Aug. 14, 2023

(51) Int. Cl. G06N 5/022; G06Q 10/087

(52) U.S. Cl. CPC G06N 5/022; G06Q 10/087

(57) ABSTRACT

An online system trains a churn prediction model to attribute a churn event to one or more causal events. The churn prediction model receives customer features and online system features as inputs. Various causal events that occur affect one or more online system features. To avoid biasing the churn prediction model using input features that are related to possible causal events, the online system determines customer features and online system features based on customer interactions occurring in different time intervals. The customer features are determined from interactions in a time interval that is earlier than a time interval from which interactions are used to determine online system features. Such time segmenting decorrelates the features input to the model from the events, reducing potential bias from the causal events on the churn prediction model.

### BACKGROUND

Online concierge systems receive orders for items from customers and allocate the orders to pickers (or shoppers), who fulfill the orders. To fulfill an order, a picker to whom the order was allocated obtains items in the order from a retailer. The picker subsequently delivers the obtained items to a customer.

Various events affect customer engagement (i.e., interaction) with an online concierge system. For example, order fulfillment times, an amount charged by the online concierge system for fulfilling an order, a number of items in an order that a picker was unable to obtain, and other events affect a likelihood of a customer subsequently engaging with the online concierge system. The online concierge system may perform various remedial actions compensating for one or more events to maintain customer engagement, with different remedial actions affecting different events.

Conventional concierge systems train a model to predict a likelihood of a customer performing a specific action within a threshold amount of time (e.g., a likelihood of receiving an order from the customer within a threshold amount of time from a most recent order by the customer). The predicted probability provides an indication of the customer subsequently engaging with the online concierge system. For example, the online concierge system determines that the customer is not going to engage with the online concierge system if the predicted probability of the customer performing a specific action within a threshold amount of time. While conventionally trained models predict the likelihood of the customer performing the action within the threshold amount of time or a predicted amount of time until the customer performs the action, conventional models are unable to accurately attribute a determined probability (or length of time) to one or more events. This prevents online concierge systems using conventional models from determining a remedial action to implement to increase a determined probability of the customer performing the specific action within the threshold time period. As different remedial actions affect different potential events, without accurately attributing a probability determined by model to an event, the online concierge system is unable to implement an optimal remedial action to mitigate a decreased probability of the customer performing the specific action within the threshold time period.

### SUMMARY

In accordance with one or more aspects of the disclosure, an online concierge system trains a churn prediction model based on historical interactions by the customer with the online concierge system. As used herein, “churn” refers to a loss of customer interaction with the online concierge system. For example, churn of a customer occurs if there is less than a threshold likelihood of the customer performing a specific action (e.g., placing an order) within a threshold time period. As another example, churn of the customer occurs if a predicted time for the customer to perform a specific action is greater than the threshold time period. The online concierge system may determine different churn prediction models for different specific actions and maintain different threshold time periods for determining churn of the customer based on different specific actions in various embodiments. The online concierge system identifies a churn event for a customer in response to at least the threshold time period passing before the customer performs the specific action. For example, the online concierge system identifies a churn event for a customer in response to an amount of time greater than the threshold time period lapsing from the customer interacting with the online concierge system without the customer performing the specific action, such as placing an order with the online concierge system.

The churn prediction model receives various features as inputs and outputs an attribution score for a churn event for each of one or more events. To train the churn prediction model for a customer, the online concierge system retrieves historical interactions by the customer with the online concierge system. In some embodiments, the historical interactions include interactions by the user occurring during a specific time range, with different historical interactions occurring at different times within the specific time range. The historical interactions include one or more churn events for various customers, with a churn event for a customer indicating a loss of engagement of the customer with the online concierge system (e.g., greater than the threshold time period between an interaction with the online concierge system by the customer and the customer performing the specific action with the online concierge system).

Certain features received by the churn prediction model are based on characteristics of the customer and the customer's preferences, while other features are affected by actions performed by the online concierge system. Features based on characteristics of the customer are referred to as “customer features,” while features based on performance of one or more actions by the online concierge system are “online concierge system features.” Both customer features and online concierge system features affect a likelihood of the customer performing the specific action within the threshold time period. Different online concierge system features are affected by one or more causal events, which influence the probability of the customer performing the specific interaction within the threshold time period. Example causal events include timeliness with which pickers fulfill orders, a number of items in an order obtained by a picker, an amount charged by the online concierge system for fulfilling an order, etc. For example, fulfillment of an order within a time interval specified by the customer for the order affects subsequent customer interaction with the online concierge system. Similarly, an amount of compensation the online concierge system charges the customer for order fulfillment or a number of items identified by an order that were unable to be obtained by a picker affects a frequency with which the customer subsequently interacts with the online concierge system.

The online concierge system may implement one or more remedial actions to offset different causal events contributing to a churn event. However, different remedial actions affect different causal events, so without accurate identification of a causal event having a maximum effect on the probability of the customer performing the specific action within the threshold time period, the online concierge system is unable to effectively mitigate a causal event. As online concierge system features affected by causal events also influence customer features, conventional training techniques for a churn prediction model use training data that is influenced by the causal events. This allows conventional churn prediction models to accurately predict a probability of a churn event, while being unable to identify a causal event with a maximum influence on the predicted probability. This inability to identify a causal event for a churn event prevents the online concierge system from implementing a remedial action for offsetting the churn event primarily influencing the determined probability of a churn event.

To more accurately select a remedial action that mitigates a decrease in probability of the customer interacting with the online concierge system (e.g., performing a specific action within the threshold time period), the online concierge system obtains training examples for a churn prediction model retrieves historical interactions by customers of the online concierge system with the online concierge system and segments the historical interactions into multiple time intervals. In various embodiments, the online concierge system segments the retrieved historical interactions into at least a first time interval and a second time interval that is later than the first time interval. For example, the online concierge system segments the historical interactions into three time intervals-a first time interval, a second time interval, and a third time interval. In various embodiments, each time interval is non-overlapping with other time intervals. Further, in various embodiments, different time intervals have different lengths. For example, the first time interval is shorter than the second time interval, or vice versa. Each time interval includes historical interactions occurring at times within a corresponding time interval. For example, the first time interval includes orders placed by one or more customers during times within the first time interval; similarly, the second time interval includes orders placed by the one or more customers during times within the second time interval. In various embodiments, the third time interval corresponds to a future time interval occurring later than a current time, so the churn prediction model is trained for predicting a probability of attributing a churn event during the third time interval to a causal event.

The online concierge system determines customer features and online concierge system features for training examples used to train the churn prediction model from different segments of the historical interactions. To decorrelate the features input to the model from one or more causal events, the online concierge system determines customer features from historical interactions occurring in a different time interval than a time interval from which online concierge system features are determined. For example, the online concierge system obtains customer features from historical interactions in a time interval that is earlier than a time interval from which online concierge system features are obtained. As the customer features are influenced by the online concierge system features, determining the customer features and the online concierge system features from different time intervals prevents data leakage between the online concierge system features and the customer features.

The customer features describe the customer's preferences and actions based on characteristics of the customer and the customer's preferences. Example customer features include an average time between the customer performing the specific action, an average number of items included in the specific action, an average amount of compensation provided by the customer for the specific action, or other characteristics. The online concierge system features describe characteristics of the online concierge system performing one or more actions. For example, the online concierge system features describe fulfillment of orders received from the customer by the online concierge system. Example online concierge system features include a time for the online concierge system to fulfill an order, whether a picker fulfilled an order within a time interval included in the order, an amount of compensation the online concierge system received for fulfilling an order, a number of items included in an order that a picker was unable to obtain, or other information describing order fulfillment by the online concierge system. In other embodiments, the online concierge system features describe attributes of performance of another specific action by the online concierge system.

As one or more events may affect an online concierge system feature, obtaining the customer features from historical interactions in a different time interval than a time interval from which online concierge system features are obtained allows the online concierge system to identify a causal event affecting subsequent interaction by the online concierge system by the customer from the trained churn prediction model. Determining the customer features and the online concierge system features from different time intervals allows the customer features to be more independent of changes to one or more online concierge system features from one or more events. From the customer features and the online concierge system features determined from historical interactions occurring in different time intervals, the online concierge system trains the churn prediction model to output a probability of attributing each of one or more causal events to a churn event based on the customer features and the online concierge system features.

The churn prediction model comprises a set of weights stored on one or more computer-readable media. These weights are parameters used by the churn prediction model to transform online concierge system features and customer features received by the churn prediction model into a probability attribution of different causal events to a churn event for a customer. The weights may be generated through a training process, where the churn prediction model is trained based on a set of training examples generated from the segmented historical interactions and labels associated with the training examples. The training examples include combinations of customer features and online concierge system features determined from the historical interactions, with a label applied to each training example indicating a causal event to which a churn event was attributed. In various embodiments, the training process includes applying the churn prediction model to a training example, comparing an output of the churn prediction model to the label associated with the training example, and updating weights of the churn prediction model through a back-propagation process. The weights may be stored on one or more computer-readable media for subsequent application to new customer features and online concierge system features.

As the trained churn prediction model predicts an attribution score for each causal event, with the attribution score for a causal event comprising a probability of attributing a churn event to the causal event in various embodiments, the online concierge system leverages the trained churn prediction model to attribute a causal event to a churn event based on the attribution scores for each causal event. For example, the online concierge system attributes a churn event to a causal event having a maximum attribution score output by the trained churn prediction model. In various embodiments, the online concierge system maintains associations between different causal events and online concierge system features. Subsequently, the online concierge system implements a remedial action corresponding to the attributed causal event, with the remedial action mitigating a reduction in a predicted probability of a customer interacting with the online concierge system incurred because of the attributed causal events.

In alternative embodiments, the online concierge system trains the churn prediction model to determine a probability of a churn event occurring for a customer based on customer features and online concierge system features. The online concierge system trains the churn prediction model using training examples from the segmented historical interactions, as further described above, with each training example including a set of customer features and a set of online concierge system features, with a label applied to a training example indicating whether a churn event occurred for a customer. In various embodiments, the training process includes applying the churn prediction model to a training example, comparing an output of the churn prediction model to the label associated with the training example, and updating weights of the churn prediction model through a back-propagation process. In such embodiments, the probability predicted by the churn prediction model does not identify how different events affect the probability of a churn event occurring. For example, the churn prediction model does not identify how a particular causal event (e.g., compensation to the online concierge system for fulfilling an order, whether the order was fulfilled during a time interval specified by the order, etc.) affects the predicted probability. As different remedial actions implemented by the online concierge system address different causal events, identifying the effect of a particular causal event on the predicted probability allows the online concierge system to implement a remedial action more likely to decrease the predicted probability.

The online concierge system may leverage the trained churn prediction model to attribute a probability of the churn event occurring to a selected online concierge system feature. In various embodiments, the online concierge system applies the trained churn prediction model to a combination of customer features and online concierge system features for a target user to determine a probability of a churn event occurring for the target user in a third time interval, which is subsequent to the second time interval. In response to a probability of the churn event occurring being greater than a threshold probability, the online concierge system determines a set of probabilities of the churn event occurring. Each probability of the set corresponds to a particular online concierge system feature having a fixed value specified by the online concierge system and other online concierge system features and customer features maintaining their values determined from the historical interactions of the customer. Thus, different probabilities of the set correspond to different specific online concierge system features having the fixed value. In various embodiments, the fixed value for a specific online concierge system feature is a maximum value for the specific online concierge system features. The set of probabilities corresponds to application of the trained churn prediction model to different modified online concierge system features, with modified online concierge system features replacing a value for a specific online concierge system feature with a fixed value, while values of the other online concierge system features are unchanged. The online concierge system applies the churn prediction model to the modified online concierge system features, determining a probability of the set corresponding to the specific online concierge system feature. Different probabilities of the set correspond to different specific online concierge system features having the fixed value.

From the set of probabilities, the online concierge system selects a minimum probability and selects the specific online concierge system feature set to the fixed value resulting in the minimum probability. Such a selection identifies the online concierge system feature that, when set to the fixed value, results in the minimum probability of the churn event occurring. The online concierge system identifies a causal event corresponding to the selected online concierge system feature and attributes the probability of the churn event occurring to the identified causal event. In various embodiments, the online concierge system maintains associations between different causal events and online concierge system features. Subsequently, the online concierge system implements a remedial action corresponding to the attributed causal event, with the remedial action compensating for the attributed causal event's effects on the probability.

Using churn prediction model to attribute a causal event to a churn event allows the online concierge system to implement a remedial measure most likely to increase a probability of the customer interacting with the online concierge system within the threshold time period (e.g., performing the specific action within the threshold time period). As the customer features and the online concierge system features for the training the churn prediction model were from different time intervals, the inputs to the churn prediction model are decorrelated from the causal events affecting the online concierge system features, allowing the trained churn prediction model to attribute a predicted probability to a causal event. This enables the online concierge system to implement a remedial action most likely to compensate for the attributed causal event to increase a subsequent probability of the customer performing the specific action within the threshold time period.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for attributing a probability of a reduction in customer interaction with an online concierge system to a causal event, in accordance with some embodiments.

FIG. 4 is a process flow diagram of a method for attributing a probability of a reduction in customer interaction with an online concierge system to a causal event, in accordance with some embodiments.

### DETAILED DESCRIPTION

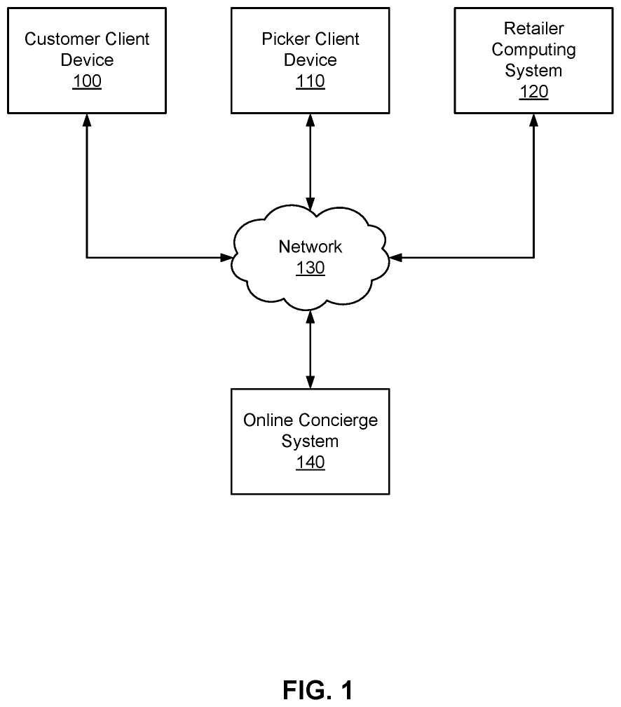

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

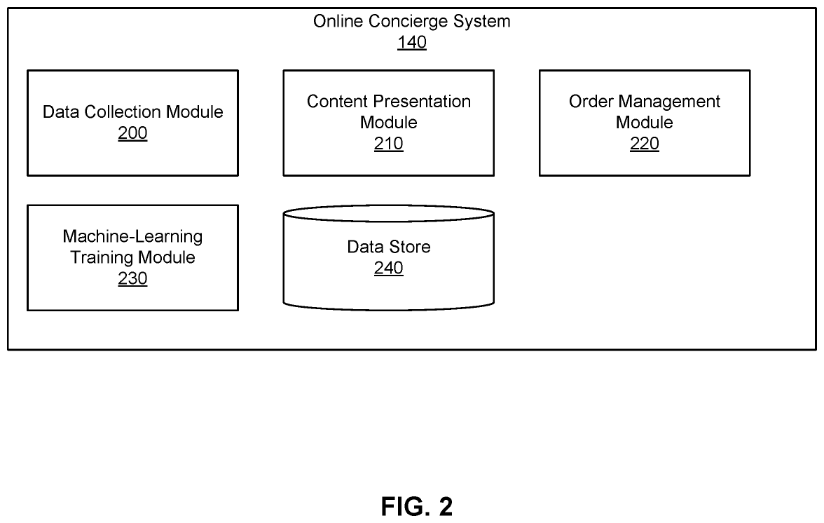

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

In various embodiments, the order management module 220 implements one or more remedial actions to offset one or more causal events affecting order fulfillment by the online concierge system 140 (or affecting completion of one or more other specific actions). Causal events affect a length of time for pickers to fulfill orders, an amount of compensation the online concierge system 140 charges a customer for fulfilling an order, a number of items included in an order that a picker is callable of obtaining from a retailer, or affect other characteristics of order fulfillment. One or more causal events may decrease a likelihood of a customer placing a subsequent order with the online concierge system 140 or may decrease a frequency with which the customer places orders with the online concierge system 140. To prevent such decreases in customer interaction from causal events, a remedial action at least partially mitigates negative effects of a causal event on an order. For example, a remedial action decreases an amount the online concierge system 140 charges a customer for fulfilling an order, while another remedial action prioritizes an order from the customer for fulfillment. Another example remedial action provides a customer with a rebate or a discount if at least a threshold amount of items in an order were not obtained by a picker.

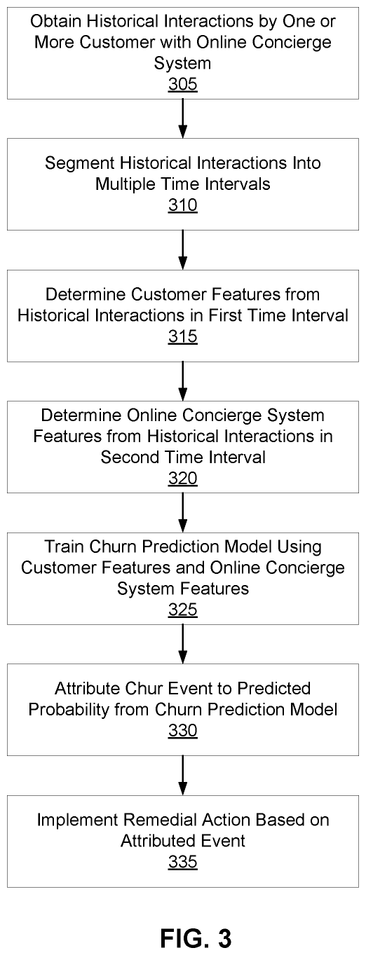

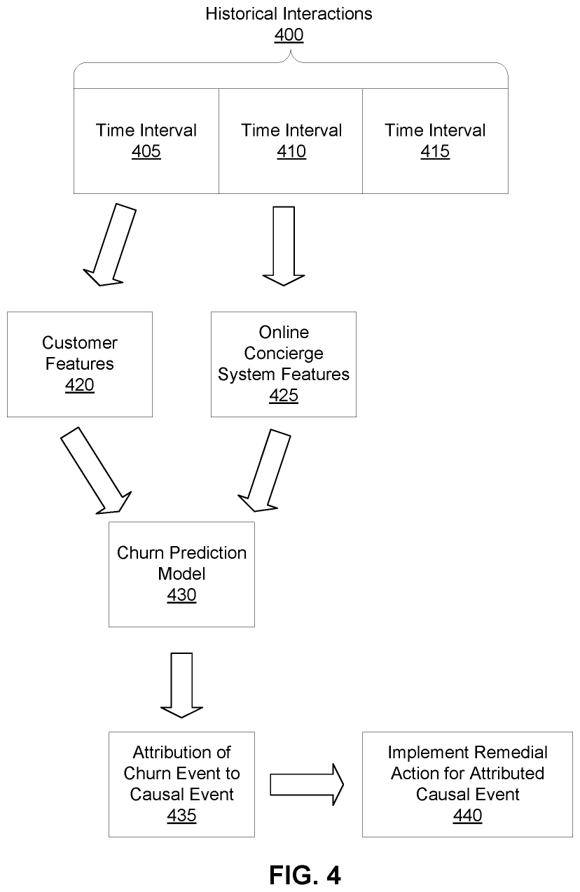

As different remedial actions mitigate different causal events, the online concierge system 140 leverages a churn prediction model, further described below in conjunction with FIGS. 3 and 4 to attribute a causal event to a churn event occurring for a customer. As used herein, “churn” refers to a loss of customer interaction with the online concierge system 140. The order management module 220 determines a “churn event” occurs for a customer in response to at least a threshold time period passing between the customer interacting with the online concierge system 140 and the customer performing a specific action, such as, such as placing an order with the online concierge system. In various embodiments, the churn prediction model is trained to output attribution scores for different causal events, with an attribution score for a causal event comprising a predicted probability of a churn event being attributed to the causal event. Alternatively, the churn prediction model predicts a probability of a churn event occurring for a customer, and the order management module 230 applies the churn prediction model to different modifications of features to select a feature that, when modified, results in a minimum probability of a churn event occurring. The order management module 230 attributes a causal event corresponding to the selected feature that, when modified, results in a minimum probability of a churn event occurring based on stored associations between features and events, as further described below in conjunction with FIGS. 3 and 4. The order management module 220 subsequently implements a remedial action corresponding to the attributed causal event to mitigate influences of the attributed causal event on subsequent customer interaction with the online concierge system 140, as further described below in conjunction with FIGS. 3 and 4.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The machine learning training module 230 trains a churn prediction model based on historical interactions by one or more customers with the online concierge system 140. As used herein, “churn” refers to a loss of customer interaction with the online concierge system 140. For example, a “churn event” of a customer occurs if there is less than a threshold likelihood of the customer performing a specific action (e.g., placing an order) within a threshold time period. As another example, a churn event of the customer occurs if a time, or a predicted time, for the customer to perform a specific action is greater than the threshold time period. The online concierge system 140 determines different churn prediction models for different specific actions in various embodiments, with different threshold time periods maintained for different specific actions.

As further described below in conjunction with FIGS. 3 and 4, when training the churn prediction model, the machine learning training module 230 retrieves historical interactions by one or more customers with the online concierge system 140 from the data store 240. In some embodiments, the historical interactions are retrieved for a specific customer, while in other embodiments the historical interactions are received for multiple users. The machine learning training module 230 segments the retrieved historical interactions into multiple time intervals, with different time intervals including historical interactions occurring at different items. In carious embodiments, the machine learning training module 230 segments the historical interactions into at least a first time interval and a second time interval that occurs later than the first time interval.

As further described below in conjunction with FIGS. 3 and 4, the machine learning training module 230 determines different features for training examples for the churn prediction model from historical interactions occurring in different time intervals. In various embodiments, the machine learning training module 230 determines features based on characteristics of the customer, referred to as “customer features,” from historical interactions in a first time interval, and determines features based on performance of one or more actions by the online concierge system 140, referred to as “online concierge system features,” from a second time interval that is later than the first time interval. Determining the customer features and the online concierge system features from different time intervals allows the customer features to be more independent of changes to one or more online concierge system features from one or more events affecting the online concierge system 140, as further described below in conjunction with FIGS. 3 and 4. From the customer feathers and the online concierge system features determined from historical interactions of the customer, the machine learning training module 230 trains the churn prediction model, as further described below in conjunction with FIG. 3.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart of a method for attributing a probability of a reduction in customer interaction with an online concierge system 140 to a causal event based on a trained churn prediction model, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 obtains 305 historical interactions with the online concierge system 140 by one or more customers. For example, the online concierge system 140 selects a customer and retrieves historical interactions with the online concierge system 140 by the selected customer from the data store 240. Alternatively, the online concierge system 140 obtains 405 historical interactions with the online concierge system 140 from different customers. In various embodiments, the obtained historical interactions occurred during a specific time period. Example historical interactions by the customer with the online concierge system 140 include orders previously received from the customer, information describing orders fulfilled for the customer by the online concierge system 140 (e.g., a number of items in an order that were not found by a picker, an amount spent by the customer on an order, whether an order was fulfilled within a time interval specified by the order, a rating the customer gave to fulfillment of an order, a time between orders received from the customer, a number of items included in each order from the customer, etc.), and may include other interactions by the customer with the online concierge system 140. The historical interactions include one or more a churn events from one or more customers, where greater than a threshold time interval lapsed between a customer interacting with the online concierge system 140 and the customer performing a specific action (e.g., placing an order) with the online concierge system 140.

The online concierge system 140 segments 310 the historical interactions with the online concierge system 140 into multiple time intervals. In some embodiments, the online concierge system 140 segments 310 the historical interactions into three time intervals. For example, the online concierge system 140 segments 310 the historical interactions into a first time interval, a second time interval, and a third time interval. In other embodiments, the online concierge system 140 segments 310 the historical interactions into at least a first time interval and a second time interval that is later than the first time interval. However, in different embodiments the online concierge system 140 segments 310 the historical interactions into any number of distinct time intervals. Interactions in different time intervals occurred at different times relative to each other. For example, historical interactions in the first time interval occurred before historical interactions in the second time interval. In some embodiments, when segmenting 310 the historical interactions, a latest time interval corresponds to future times in some embodiments. For example, when the historical interactions are segmented 310 into three time intervals, the first time interval and the second time interval include interactions that have occurred, while the third time interval includes times in the future.

Different time intervals have different durations in various embodiments. In various embodiments, a duration of at least time interval varies each time the historical interactions are segmented 310. For example, the second time interval is a different duration each time the online concierge system 140 segments 310 historical interactions by the customer. Multiple time intervals include multiple specific actions performed by one or more customers, such as multiple orders received from the customer. For example, the first time interval and the second time interval each include multiple orders from the customer.

With the historical interactions by the customer segmented 310 into different time intervals, the online concierge system 140 determines 315 a set of customer features from historical interactions occurring during a first time interval. In various embodiments, the first time interval includes the earliest interactions by the customer with the online concierge system 140. The customer features are based on characteristics of the customer and describe how the customer interacts with the online concierge system 140. Example customer features include an average time between orders received from the customer, an average number of items included in orders received from the customer, a number of orders received from the customer, an average cost of items included in orders received from the customer, or other information describing ordering habits (or habits of performing another specific action) from the user. Each of the customer features is determined 315 from orders (or from other specific actions) received from the customer during the first time interval, without considering specific actions, such as orders, the customer performed in other time intervals. In various embodiments, the first time interval is an earliest time interval of the historical interactions.

While the customer features describe the customer's interaction with the online concierge system 140, characteristics of how the online concierge system 140 fulfills an order or responds to another specific action from the customer influence how the customer subsequently interacts with the online concierge system 140. For example, delays in order fulfillment by the online concierge system 140 may increase an amount of time between orders received from the customer, while fulfilling orders within a time interval specified by the order may decrease the amount of time between orders received from the customer. To account for characteristics of performance of one or more actions by the online concierge system 140, a set of online concierge system features that describe performance of one or more actions by the online concierge system 140 are determined 320 from a second time interval. The second time interval is different than the first time interval, and in various embodiments, the second time interval is later than the first time interval. Example online concierge system features include a rate at which pickers found items included in orders from the customer, a number of orders fulfilled later than a time interval specified by a corresponding order, a rate at which orders were fulfilled later than time intervals specified by corresponding orders, an average amount the online concierge system 140 charged the customer for fulfilling orders, or other information describing order fulfillment by the online concierge system 140 for the customer. In various embodiments, the online concierge system 140 determines 315 the customer features from historical interactions in the first time interval without accounting for historical interactions in other time intervals and limits historical interactions for determining 320 the online concierge system features to historical interactions occurring in the second time interval. As the online concierge system features influence the customer features, determining 320 the online concierge system features from historical interactions in a different time interval (e.g., a later time interval) than the time interval from which the customer features are determined 315 mitigates introduction of bias from online concierge system features into customer features.

As the online concierge system features describe performance of actions, such as fulfillment of orders, one or more causal events occurring during the second time interval from which the online concierge system features are determined 320 affect one or more online concierge system features. For example, a causal event changing availability of items at one or more retailers affects an amount of items included in an order that pickers obtain. As another example, a causal event changing a rate at which pickers fulfill orders within time intervals specified by the orders similarly affects an online concierge system feature describing a rate at which orders were fulfilled later than time intervals specified by corresponding orders. In another example, a causal event changes an amount charged by the online concierge system 140 for fulfilling orders, affecting an online concierge system feature. As the online concierge system features affect a probability of the customer subsequently performing a specific action, changes in an online concierge system features from one or more causal events affects the probability of a churn event occurring for a customer (e.g., affects a probability of the customer performing the specific action within a threshold time period).

The online concierge system 140 may implement one or more remedial actions to offset one or more causal events affecting one or more online concierge system features. Different remedial actions offset different types of causal events, so the online concierge system 140 performs different remedial actions to compensate for different causal events that occur. For example, a remedial action decreases an amount of compensation the online concierge system 140 receives from a customer for performing a specific action. Another example remedial action provides a discount or a rebate to a customer in response to a picker obtaining less than a threshold number of items in an order. In another example remedial action, the online concierge system 140 increases a priority of an order from the customer to reduce an amount of time for a picker to select the order or provides the customer with a rebate or a discount in response to a picker fulfilling the order later than a time interval included in the order.

However, multiple events may affect an online concierge system feature, so determining which causal event affects the probability of a churn event occurring or affects a churn event that occurred allows the online concierge system 140 select which remedial action is implemented. To attribute a churn event to a causal event, the online concierge system 140 trains 325 a churn prediction mode based on the customer features and the online concierge system features determined from the temporally segmented historical interactions, as further described above. The churn prediction model receives a combination of customer features and online concierge system features as inputs and outputs an attribution score for each of one or more causal events, with the attribution score for a causal event comprising a predicted probability of attribution of the churn event to the causal event in various embodiments. Alternatively, the churn prediction model determines a probability of a churn event occurring for a customer based on the customer features and the online concierge system features. To train 325 the churn prediction model, the online concierge system 140 generates a training dataset including multiple training examples based on the historical interactions retrieved 305 and from the customer features and online concierge system features determined from different time intervals of the historical interactions, as further described above. Each training example includes one or more customer features and one or more online concierge system features. As further described above, the customer features are determined 315 from historical interactions occurring in a different time interval than historical interaction used to determine 320 the online concierge system features. A label indicating one or more causal events attributed to a churn event corresponding to a training example is applied to each training example. In other embodiments, a label is applied to a training example indicating whether a churn event occurred. For example, the label has a first value in response to a churn event occurring for a customer (e.g., the online concierge system 140 did not receive a specific action from the customer during the threshold time period) and has a second value in response to a churn event not occurring for the customer (e.g., the customer performing the specific action during the threshold time period). Different training examples include different combinations of customer features and online concierge system features occurring in various sequences in the obtained historical interactions.

The churn prediction model comprises a set of weights stored on a non-transitory computer readable storage medium in various embodiments. For training, the online concierge system 140 initializes a network of a plurality of layers comprising the churn prediction model, with each layer including one or more weights. Different weights are applied to different customer features and to different online concierge system features in various embodiments. For example, a weight is applied to each customer feature and a weight is similarly applied to each online concierge system feature. The churn prediction model receives a combination of customer features and online concierge system features and determines an attribution score for each of one or more causal events. The attribution score for a causal event is a predicted probability of attribution of a churn event to the causal event. Hence, the weights comprise a set of parameters used by the churn prediction model to transform the input data—the customer features and the online concierge system features—received by the churn prediction model into output data—attribution scores for each of one or more causal events. In other embodiments, the churn prediction model transforms the customer features and the online concierge system features into a probability of a churn event occurring.

After initializing the set of weights comprising the churn prediction model, the online concierge system 140 applies the churn prediction model to multiple training examples of the training dataset to generate the parameters (e.g., the weights) for the churn prediction model. As further described above, in various embodiments, a training example includes a combination of customer features and online concierge system features. A label applied to the training example indicates one or more causal events attributed to a churn event in various embodiments (or indicates whether a churn event occurred). Applying the churn prediction model to a training example generates an attribution score for each of one or more causal events given the customer features and the online concierge system features in the training example in various embodiments. The attribution score for a causal event is a predicted probability of attribution of a churn event to the causal event. In other embodiments, applying the churn prediction model to a training example generates a predicted probability of a churn event occurring.

For each training example to which the churn prediction model is applied, the online concierge system 140 generates a score comprising an error term based on the one or more attribution scores based on the customer features and the online concierge system features in a training example and the label applied to the training example. The error term is larger when a difference between the predicted one or more attribution scores and the label applied to the training example is larger and is smaller when the difference between the predicted one or more attribution scores and the label applied to the training example is smaller. In various embodiments, the online concierge system 140 generates the error term using a loss function based on a difference between the predicted probability of a churn event occurring and the label applied to the training example using a loss function. Example loss functions include a mean square error function, a mean absolute error, a hinge loss function, and a cross-entropy loss function.

The online concierge system 140 backpropagates the error term to update the set of parameters comprising the churn prediction model and stops backpropagation in response to the error term, or to the loss function, satisfying one or more criteria. For example, the online concierge system 140 backpropagates the error term through the churn prediction model to update parameters of the churn prediction model until the error term has less than a threshold value. For example, the online system 140 may apply gradient descent to update the set of parameters. The online concierge system 140 stores the set of parameters comprising the churn prediction model on a non-transitory computer readable storage medium after stopping the backpropagation.

In various embodiments, the online concierge system 140 trains 325 the churn prediction model for the customer, so the churn prediction model is tailored to a specific customer based on the customer's historical interactions with the online concierge system 140. In such embodiments, the online concierge system 140 trains 325 a different churn prediction model for each customer. The online concierge system 140 stores a trained churn prediction model in association with an identifier of a corresponding customer in various embodiments.

Training 325 the churn prediction model using customer features and online concierge system features determined from historical interactions in different time intervals allows the churn prediction model to also be used to attribute 330 a new churn event identified for a target user to a causal event based on attribution scores output from the churn prediction model that likely caused the new churn event. This attribution allows the online concierge system 140 to leverage the churn prediction model, after training 325, to select a remedial action to offset effects of the attributed churn event on the probability of the target customer interacting with the online concierge system 140 within the threshold time period. In various embodiments, the online concierge system 140 attributes 330 the new churn event for the target user to a causal event having a maximum attribution score from the trained churn prediction model.

Based on the event causal attributed 330 to the new churn event for the target customer, the online concierge system 140 implements 335 a remedial action. The remedial action at least partially offsets an effect of the attributed causal event on the probability of the target user interacting with the online concierge system 140 during the threshold time period. Hence, the remedial action mitigates a decrease in the predicted probability of the customer performing ae specific action within the threshold time period caused by the attributed causal event in various embodiments. Different remedial actions offset different types of causal events, so attributing 330 a causal event to the new churn event allows implementation of a remedial action most likely to reduce an amount by which the attributed causal event changes the predicted probability of the customer interacting with the online concierge system 140. For example, a remedial action decreases an amount the online concierge system 140 charges for fulfilling an order. An alternative remedial action adjusts allocation of an order to one or more pickers to increase a rate at which the orders are fulfilled during corresponding time intervals included in the orders. Another remedial action compensates for an item included in the order being unavailable at a retailer (e.g., providing a discount for an alternative item for an item that is unavailable, providing a credit to the customer in response to one or more items in orders being unavailable at a retailer).

The online concierge system 140 associates different remedial actions with different causal events, enabling selection of a remedial action associated with the attributed causal event. Thus, leveraging the churn prediction model allows the online concierge system to implement 335 a remedial action to compensate for a causal event most likely affecting the online concierge system feature with a maximum contribution to the new churn event. For example, a remedial action decreases an amount of compensation charged by the online concierge system 140 to a customer for fulfilling an order in response attributing 330 the new churn event to a causal event indicating a prior increase in the amount of compensation charged by the online concierge system 140. In another example, the online concierge system 140 implements 335 a remedial action increasing likelihood of selection of an order from the customer by a picker or increasing an incentive to a picker for fulfilling the order in a time interval specified by the order in response to the online concierge system 140 attributing 330 the new churn event to a causal event delaying prior fulfillment of orders for the customer. As another example, the online concierge system 140 implements 335 a remedial action providing a discount or compensation to the customer when a picker is unable to obtain at least a threshold number of items in an order when attributing 330 the new churn event to a causal event where an order for the customer included at least a threshold amount of replacement items or where the order did not include at least a threshold number of items included in the order.

In embodiments where the churn prediction model outputs a predicted probability of a new churn event based on online concierge system features and customer features associated with the new churn event, the online concierge system 140 determines a set of probabilities of the new churn event occurring using the churn prediction model. Each probability of the set corresponds to a different online concierge system feature having a fixed value determined by the online concierge system 140, while values of other online concierge system features are unchanged. In some embodiments, the fixed value is a maximum value for a corresponding online concierge system features, so different probabilities of the set indicate how maximizing a value of a specific online concierge system affects the predicted probability of the new churn event occurring.

To determine the set of probabilities, the online concierge system 140 selects previously determined online concierge system features and generates a set of modified online concierge system features. The set of modified online concierge system features includes different elements, with each element comprising the set of online concierge system features with a value of specific online concierge system feature replaced with the fixed value, while the values of other online concierge system features are unchanged. Different elements in the set of modify online concierge system features corresponding to replacing different specific online concierge system features with the fixed value.

The online concierge system 140 applies the churn prediction model to each element of the set of modified online concierge system features, generating a set of probabilities of the customer performing the specific action within the threshold time period. Each probability of the set corresponds to a value of a different online concierge system feature being replaced with the fixed value. In various embodiments, the online concierge system 140 determines a difference between each predicted probability of the new churn event occurring from the modified online concierge system features of the set and the predicted probability of the new churn event occurring when no value of an online concierge system features is modified. The online concierge system 140 selects an online concierge system feature that, when having the fixed value, corresponds to a maximum difference. This allows the online concierge system 140 to select an online concierge system feature for which a change in value results in a maximum effect on the predicted probability of the new churn event. The online concierge system 140 maintains associations between different online concierge system features and different causal events, so the online concierge system 140 attributes 330 the predicted probability to a causal event associated with the selected online concierge system feature. This allows the online concierge system 140 to evaluate how different causal events affect the predicted probability of the new churn event based on how values of different online concierge system features, which are affected by different causal events, change the predicted probability of the new causal event occurring.

Alternatively, the online concierge system 140 attributes 330 the new churn event to a causal event using weights that the churn prediction model applies to different online concierge system attributes and values of the online concierge system attributes. In various embodiments, the online concierge system 140 determines a set of products, with each product determined by multiplying a determined value for the online concierge system feature by a corresponding weight for the online concierge system feature from the churn prediction model. The online concierge system 140 selects an online concierge system feature associated with a maximum product of the set and attributes 330 the new churn event to a causal event associated with the selected online concierge system feature. This allows the online concierge system 140 to leverage training 325 of the churn prediction model, which determined weights applied to different online concierge system features on how different online concierge system features affect the predicted probability of a churn event occurring output by the churn prediction model to attribute 330 a causal event to a predicted probability of the churn event occurring.

FIG. 4 is a process flow diagram of a method for attributing a churn event to a causal event based on a trained churn prediction model. As further described above in conjunction with FIGS. 2 and 3, “churn” refers to a loss of customer interaction with the online concierge system. For example, churn of a customer occurs if there is less than a threshold likelihood of the customer performing a specific action (e.g., placing an order) within a threshold time period. As another example, churn of the customer occurs if a predicted time for the customer to perform a specific action is greater than the threshold time period. In various embodiments, the online concierge system 140 identifies “churn event” occurring for a customer in response to at least a threshold time period passing between the customer interacting with the online concierge system 140 and the customer performing a specific action, such as, such as placing an order with the online concierge system 140.

The online concierge system 140 trains a churn prediction model for a customer based on historical interactions 400 by one or more customers with the online concierge system 140. The online concierge system 140 may determine different churn prediction models for different specific actions and maintain different threshold time periods for determining churn of the customer based on different specific actions in various embodiments. The churn prediction model receives various features as inputs and outputs an attribution score for each of one or more causal events. The attribution score for a causal event is a predicted probability of attribution of a churn event to the causal event. Alternatively, the churn prediction model outputs a predicted probability of a churn event occurring based on the features received as input. In some embodiments, the historical interactions 400 include interactions by one or more customers occurring during a specific time period, with different historical interactions 400 occurring at different times. For example, different historical interactions 400 are orders placed by the customer at different times. The historical interactions 400 include one or more churn events identified for one or more customers, as further described above in conjunction with FIG. 3.

From the historical interactions 400, the online concierge system determines customer features 420, which are based on characteristics of the customer, and online concierge system features 425, which are based on performance of one or more actions by the online concierge system 140. Both the customer features 420 and the online concierge system features 425 affect a probability of a churn event occurring. Further, online concierge system factors are affected by one or more causal events affecting performance of an action by the online concierge system 140. Example causal events include timeliness with which pickers fulfill orders, a number of items in an order obtained by a picker, an amount charged by the online concierge system 140 for fulfilling an order, etc. For example, fulfillment of an order within a time interval specified by the customer for the order affects subsequent customer interaction with the online concierge system 140. Similarly, an amount of compensation the online concierge system charges the customer for order fulfillment or a number of items identified by an order that were unable to be obtained by a picker affects a frequency with which the customer subsequently interacts with the online concierge system 140.

The online concierge system 140 may implement one or more remedial actions to offset different causal events. However, different remedial actions affect different causal events, so the online concierge system 140 is unable to effectively mitigate an event without accurately identifying a causal event having a maximum effect on the probability of a churn event occurring. As online concierge system features 425 affected by events also influence customer features 420, conventional techniques for training a churn prediction model use training data that is influenced by the causal events. While this results in a churn prediction model that predicts a probability of a churn event occurring, such a conventionally trained churn prediction model does not enable identification of a causal event having a maximum influence on the predicted probability of a causal event occurring. This inability to identify a causal event leading to a churn event for a customer prevents the online concierge system 140 from implementing a remedial action to increase a probability of subsequent interaction by the customer with the online concierge system 140 most effectively.

To more accurately select a remedial action mitigating a decrease in predicted probability of the interacting with the online concierge system 140, the online concierge system 140 segments the historical interactions 400 into multiple time intervals. In the example of FIG. 4, the online concierge system 140 segments the historical interactions 400 into three time intervals-a first time interval 405, a second time interval 410, and a third time interval 415. In various embodiments, each time interval is non-overlapping with other time intervals. Further, in various embodiments, different time intervals have different lengths. For example, the first time interval 405 is shorter than the second time interval 410, or vice versa. Each time interval includes historical interactions occurring at times within the time interval. For example, the first time interval 405 includes orders placed by the customer during times within the first time interval 405; similarly, the second time interval 410 includes orders placed by the customer during times within the second time interval 410. In various embodiments, the third time interval 415 corresponds to a future time interval occurring later than a current time, so the churn prediction model is trained from historical interactions 400 in the first time interval 405 and in the second time interval 410 to predict attribution scores for different causal events for a churn event identified during the third time interval 415.

The online concierge system 140 determines the customer features 420 and the online concierge system features 425 from different time intervals to decorrelate the customer features 420 and the online concierge system features 425 from causal events affecting performance of actions by the online concierge system 140. For example, the online concierge system 140 determines the customer features 420 from historical interactions 400 in the first time interval 405, which is earlier than the second time interval 410. The online concierge system 140 determines the online concierge system features 425 from historical interactions 400 occurring during the second time interval 410. As the customer features 420 are influenced by the online concierge system features 425, determining the customer features 420 and the online concierge system features 425 from different time intervals prevents data leakage between the online concierge system features 425 and the customer features 420.

The customer features 420 describe the customer's preferences and actions based on characteristics of the customer and the customer's preferences. Example customer features 420 include an average time between the customer performing the specific action, an average number of items included in the specific action, an average amount of compensation provided by the customer for the specific action, or other characteristics. The online concierge system features 425 describe characteristics of the online concierge system 140 performing one or more actions. For example, the online concierge system features 425 describe fulfillment of orders received from the customer by the online concierge system 140. Example online concierge system features 425 include a time for the online concierge system 140 to fulfill an order, whether a picker fulfilled an order within a time interval included in the order, an amount of compensation the online concierge system 140 received for fulfilling an order, a number of items included in an order that a picker was unable to obtain, or other information describing order fulfillment by the online concierge system 140. In other embodiments, the online concierge system features 425 describe characteristics of performance of another specific action by the online concierge system 140.

As one or more casual events may affect an online concierge system feature 425, determining the customer features 420 from historical interactions 400 in a different time interval than the online concierge system features 425 enables identification of a causal event affecting subsequent interaction by the online concierge system 140 by the customer from the trained churn prediction model. Determining the customer features 420 and the online concierge system features 425 from different time intervals allows the customer features 420 to be more independent of changes to one or more online concierge system features 425 from one or more causal events. From the customer features 420 and the online concierge system features 425 determined from historical interactions 400 occurring in different time intervals, the online concierge system 140 trains the churn prediction model 430 to output attribution scores for each of one or more causal events based on the customer features 420 and the online concierge system features 425. An attribution score for a causal event is a predicted probability of a churn event being attributed to the causal event. In other embodiments, the churn prediction modes 430 is trained to output a probability of a churn event occurring based on customer features 420 and online concierge system features 425.

As further described above in conjunction with FIG. 3, the churn prediction module 430 comprises a set of weights that transform a combination of customer features 420 and online concierge system features 425 into one or more attribution scores for various causal events (or a predicted probability of a causal event occurring). As further described above in conjunction with FIGS. 2 and 3, the churn prediction model 430 is trained from a set of training examples generated from the historical interactions 400 by the customer. After training, the churn prediction model 430 is stored on one or more computer readable storage media for application to new customer features 420 and online concierge system features 425.

With the trained churn prediction model 430 stored, when the online concierge system 140 identifies a new churn event associated with a target user, the online concierge system 140 applies the churn prediction model 430 to customer features 420 and online concierge system features 425 based on historical interactions by the target user. Based on the output of the churn prediction model 430, the online concierge system 140 attributes 435 the churn event to a causal event. In embodiments where the churn prediction model 430 outputs attribution scores for each of one or more causal events, the online concierge system 140 attributes 435 the new churn event to a causal event having a maximum attribution score. In some embodiments, the online concierge system 140 ranks causal events based on their attribution scores and attributes 435 the new churn event to one or more causal events having at least a threshold position in the ranking. The online concierge system 140 determines an online concierge system feature associated with the attributed causal event and implements 440 a remedial action associated with the determined online concierge system feature. As different remedial actions implemented by the online concierge system 140 mitigate different causal events, attributing 435 the new churn event to a causal event allows implementation of a remedial action more likely to increase a predicted probability of the target user subsequently interacting with the online concierge system 140.

In embodiments where the trained churn prediction model 430 predicts a probability of a churn event occurring, to attribute 435 a causal event to the new churn event, the online concierge system 140 applies the trained churn prediction model 430 to a combination of customer features 420 and online concierge system features 425 for the new churn event in the third time interval 415, which is subsequent to the second time interval 410. In response to identifying a churn event for a target user, the online concierge system 140 determines a set of probabilities of the churn event occurring for the target user. Each probability of the set corresponds to a particular online concierge system feature 425 having a fixed value determined by the online concierge system 140, such as a maximum value for the online concierge system feature 425, while values of other online concierge system features 425 are unchanged. Hence, different probabilities of the set correspond to different specific online concierge system features 425 being modified to a corresponding fixed value. To determine the set of probabilities, the online concierge system 140 selects previously determined online concierge system features 425 corresponding to the churn event and replaces a value for a specific online concierge system feature 425 with a fixed value, while leaving values of the other online concierge system features 425 unchanged, generating modified online concierge system features. The online concierge system 140 applies the churn prediction model 430 to the modified online concierge system features to determine a probability of the set corresponding to the specific online concierge system feature 425 modified to have the fixed value.

From the set of probabilities, the online concierge system 140 selects a minimum probability and selects the specific online concierge system feature modified to the fixed value that corresponds to the maximum probability. Such selection identifies the online concierge system feature 425 that, when set to the fixed value, results in the minimum probability of the churn event occurring for the target customer. So, the selected online concierge system feature causes a maximum change in a probability of the target customer interacting with the online concierge system 140. Based on stored associations between online concierge system features 425 and events, the online concierge system 140 attributes 435 a causal event associated with the selected online concierge system feature 425 to the churn event identified for the target customer. Subsequently, the online concierge system 140 implements 440 a remedial action corresponding to the attributed causal event to mitigate one or more effects of the attributed causal event on the probability of the target customer interacting with the online concierge system 140.

Using the set of probabilities from the trained churn prediction model 430 to determine effects of changes to different online concierge system features 425 allows the online concierge system 140 to implement 440 a remedial measure most likely to decrease a probability of a churn event for the target customer. As the customer features 420 and the online concierge system features 425 for the training the churn prediction model 430 were determined from different time intervals, the inputs to the churn prediction model 430 are decorrelated from the events affecting the online concierge system features 425. This allows the churn prediction model 430 to be leveraged to attribute 435 a causal event to a churn event to implement 440 a remedial action most likely to decrease a probability of a churn event occurring for the target customer.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
obtaining a training dataset comprising a plurality of training examples, wherein each training example is generated by:
retrieving historical interactions by a user of a plurality of users with an online system, wherein the historical interactions for the user include a churn event indicating a loss of engagement of the user with the online system,
segmenting the historical interactions into at least a first time interval and a second time interval that is after the first time interval,
obtaining a set of user features from the historical interactions occurring in the first time interval,
obtaining a set of online system features from the historical interactions occurring in the second time interval, wherein the historical interactions occurring in the second time interval include one or more causal events, and
labeling an attribution of the churn event to one or more of the causal events;
training a churn prediction model, wherein the churn prediction model is trained by:
applying the churn prediction model to each training example of the training dataset to generate an attribute score for each of the causal events, the attribute score for a causal event comprising a predicted probability of the attribution of the churn event the causal event,
scoring the churn prediction model using a loss function and the label of the training example, and
updating one or more parameters of the churn prediction model by backpropagation based on the scoring until one or more criteria are satisfied;
identifying a new churn event associated with a target user of the online system;
applying the churn prediction model to a set user features and online system features from historical interactions by the target user with the online system, the churn prediction model outputting an attribution score for each of the one or more causal events;
attributing a causal event to the new churn event based on the attribution scores; and
implementing a remedial action corresponding to the attributed causal event, wherein implementing the remedial action mitigates a reduction in a predicted probability of the target user interacting with the online system.

2. The method of claim 1, wherein the new churn event comprises greater than a threshold time period lapsing between the target user interacting with the online system and the target user performing a specific action with the online system.

3. The method of claim 2, wherein the specific action comprises placing an order with the online system.

4. The method of claim 1, wherein attributing the causal event to the new churn event based on the attribution scores comprises:
selecting a causal event having a maximum attribution score.

5. The method of claim 1, wherein attributing the causal event to the new churn event based on the attribution scores comprises:
ranking the one or more causal events based on the attribution scores; and
selecting one or more causal events having at least a threshold position in the ranking.

6. The method of claim 1, wherein identifying the set of user features comprises identifying an average time between performance of a specific action by the user.

7. The method of claim 1, wherein identifying the set of online system features comprises identifying one or more of: a rate at which pickers found items included in orders from the user, a number of orders fulfilled later than a time interval specified by a corresponding order, a rate at which orders were fulfilled later than time intervals specified by corresponding orders, or an average amount the online system charged the user for fulfilling orders.

8. The method of claim 1, wherein the causal event is selected from a group consisting of: timeliness with which pickers fulfill orders received by the online system, a number of items included an order obtained by a picker, an amount charged by the online system for fulfilling an order, and any combination thereof.

9. The method of claim 1, wherein the new churn event occurs in a third time interval that is later than the second time interval.

10. A computer program product comprising a non-transitory computer readable storage medium having instructions encoded thereon that, when executed by a processor, cause the processor to perform steps comprising:
obtaining a training dataset comprising a plurality of training examples, wherein each training example is generated by:
retrieving historical interactions by a user of a plurality of users with an online system, wherein the historical interactions for the user include a churn event indicating a loss of engagement of the user with the online system,
segmenting the historical interactions into at least a first time interval and a second time interval that is after the first time interval,
obtaining a set of user features from the historical interactions occurring in the first time interval,
obtaining a set of online system features from the historical interactions occurring in the second time interval, wherein the historical interactions occurring in the second time interval include one or more causal events, and
labeling an attribution of the churn event to one or more of the causal events;
training a churn prediction model, wherein the churn prediction model is trained by:
applying the churn prediction model to each training example of the training dataset to generate an attribute score for each of the causal events, the attribute score for a causal event comprising a predicted probability of the attribution of the churn event the causal event,
scoring the churn prediction model using a loss function and the label of the training example, and
updating one or more parameters of the churn prediction model by backpropagation based on the scoring until one or more criteria are satisfied;
identifying a new churn event associated with a target user of the online system;
applying the churn prediction model to a set user features and online system features from historical interactions by the target user with the online system, the churn prediction model outputting an attribution score for each of the one or more causal events;
attributing a causal event to the new churn event based on the attribution scores; and
implementing a remedial action corresponding to the attributed causal event, wherein implementing the remedial action mitigates a reduction in a predicted probability of the target user interacting with the online system.

11. The computer program product of claim 10, wherein the new churn event comprises greater than a threshold time period lapsing between the target user interacting with the online system and the target user performing a specific action with the online system.

12. The computer program product of claim 11, wherein the specific action comprises placing an order with the online system.

13. The computer program product of claim 10, wherein attributing the causal event to the new churn event based on the attribution scores comprises:
selecting a causal event having a maximum attribution score.

14. The computer program product of claim 10, wherein attributing the causal event to the new churn event based on the attribution scores comprises:
ranking the one or more causal events based on the attribution scores; and
selecting one or more causal events having at least a threshold position in the ranking.

15. The computer program product of claim 10, wherein identifying the set of user features comprises identifying an average time between performance of a specific action by the user.

16. The computer program product of claim 10, wherein identifying the set of online system features comprises identifying one or more of: a rate at which pickers found items included in orders from the user, a number of orders fulfilled later than a time interval specified by a corresponding order, a rate at which orders were fulfilled later than time intervals specified by corresponding orders, or an average amount the online system charged the user for fulfilling orders.

17. The computer program product of claim 10, wherein the causal event is selected from a group consisting of: timeliness with which pickers fulfill orders received by the online system, a number of items included an order obtained by a picker, an amount charged by the online system for fulfilling an order, and any combination thereof.

18. The computer program product of claim 10, wherein the new churn event occurs in a third time interval that is later than the second time interval.

19. A system comprising:
a processor; and
a non-transitory computer readable storage medium having instructions encoded thereon that, when executed by the processor, cause the processor to perform steps comprising:
obtaining a training dataset comprising a plurality of training examples, wherein each training example is generated by:
retrieving historical interactions by a user of a plurality of users with an online system, wherein the historical interactions for the user include a churn event indicating a loss of engagement of the user with the online system,
segmenting the historical interactions into at least a first time interval and a second time interval that is after the first time interval,
obtaining a set of user features from the historical interactions occurring in the first time interval,
obtaining a set of online system features from the historical interactions occurring in the second time interval, wherein the historical interactions occurring in the second time interval include one or more causal events, and
labeling an attribution of the churn event to one or more of the causal events;
training a churn prediction model, wherein the churn prediction model is trained by:
applying the churn prediction model to each training example of the training dataset to generate an attribute score for each of the causal events, the attribute score for a causal event comprising a predicted probability of the attribution of the churn event the causal event,
scoring the churn prediction model using a loss function and the label of the training example, and
updating one or more parameters of the churn prediction model by backpropagation based on the scoring until one or more criteria are satisfied;
identifying a new churn event associated with a target user of the online system;
applying the churn prediction model to a set user features and online system features from historical interactions by the target user with the online system, the churn prediction model outputting an attribution score for each of the one or more causal events;
attributing a causal event to the new churn event based on the attribution scores; and
implementing a remedial action corresponding to the attributed causal event, wherein implementing the remedial action mitigates a reduction in a predicted probability of the target user interacting with the online system.

20. The system of claim 19, wherein attributing the causal event to the new churn event based on the attribution scores comprises:
selecting a causal event having a maximum attribution score.
